(19) United States
(12) Patent Application Publication
(10) Pub. No.: US 2006/0046044 A1
(43) Pub. Date: Mar. 2, 2006

(54) Porous composite polymer dielectric film

(76) Inventors: Chung J. Lee, Fremont, CA (US); Atul Kumar, Santa Clara, CA (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 10/925,701

(22) Filed: Aug. 24, 2004

(51) Int. Cl. B29C 65/00; B32B 3/26

(52) U.S. Cl. 428/304.4; 428/411.1; 264/41

(57) ABSTRACT

A method of forming a composite dielectric polymer thin film on a substrate is disclosed, wherein the method includes forming a first substantially continuous layer of a dielectric polymer material on the substrate, forming a porous layer of the dielectric polymer material on the first, substantially continuous layer, and forming a second substantially continuous layer of the dielectric polymer material on the porous layer.

### BACKGROUND

Integrated circuits contain many different layers of materials, including dielectric layers that insulate adjacent conducting layers from one another. With each decrease in the size of integrated circuits, the individual conducting layers and elements within the integrated circuits grow closer to adjacent conducting elements. This necessitates the use of dielectric layers made of materials with low dielectric constants to prevent problems with capacitance, cross talk, etc. between adjacent conducting layers and elements.

Future integrated circuits are expected to have conductive elements spaced extremely close together—for example, on the order of 65 nanometers or less. Such close spacing may require the use of dielectric materials having dielectric constants on the order of 2 or lower. Commonly used dielectric materials, both inorganic (for example, SiO₂, fluorine doped SiO₂, C and H doped SiO₂, etc.) and organic (for example, polymers such as SiLK, available from Dow Chemical Company), have dielectric constants too high (ε≧2.7) for use in integrated circuits of this small a scale when deposited as a continuous film.

Porous films of dielectric materials such as SiO₂ and MSQ (poly(methyl silesquioxane)), as opposed to continuous films, may have dielectric constants of 2 or less, and thus may be suitable for use in sub-65 nanometer integrated circuits. However, the pores present in films of these materials may present challenges in integrating these films into later processing steps. For example, the pores may make it difficult to form smooth, continuous cap layers, etch stop layers and/or barrier layers in a single or dual damascene process.

To solve such problems, depositions of continuous layers of materials such as SiO2, SiOCH, PPX—N (a polymer having a repeating unit of —CH₂C₆H₄CH₂—) Ta, TaN directly onto porous materials via atomic layer deposition (ALD) or chemical vapor deposition (CVD) have been proposed. However, the porous dielectric films are typically deposited via spin-on processes. Therefore, the use of ALD or CVD to form the continuous overlayer would require the use of additional tools and steps, and may therefore increase the amount of time and cost required for circuit fabrication.

### SUMMARY

A method of forming a composite dielectric polymer thin film on a substrate is disclosed, wherein the method includes forming a first substantially continuous layer of a dielectric polymer material on the substrate, forming a porous layer of the dielectric polymer material on the first substantially continuous layer, and forming a second substantially continuous layer of the dielectric polymer material on the porous layer.

### BRIEF DESCRIPTION OF THE DRAWINGS

FIG. 1 is a greatly magnified, sectional view of an embodiment of a substrate having an electrically conductive layer, an etch stop layer and a first continuous polymer layer.

FIG. 2 is a greatly magnified, sectional view of the embodiment of FIG. 1, wherein a polymer layer including an incorporated pore-forming component is formed on the first continuous polymer layer.

FIG. 3 is a greatly magnified, sectional view of the embodiment of FIG. 2, wherein the pore-forming component has been removed to form the porous polymer layer.

FIG. 4 is a greatly magnified, sectional view of the embodiment of FIG. 3, wherein a second continuous polymer layer is formed on the porous polymer layer.

FIG. 5 is a greatly magnified, sectional view of the embodiment of FIG. 4, wherein a hard mask layer is formed on the second continuous polymer layer.

FIG. 6 is a greatly magnified, sectional view of the embodiment of FIG. 5, wherein a layer of resist is formed on the hard mask layer.

FIG. 7 is a greatly magnified, sectional view of the embodiment of FIG. 6, wherein the layer of resist has been developed and patterned.

FIG. 8 is a greatly magnified, sectional view of the embodiment of FIG. 7, wherein the hard mask layer has been etched.

FIG. 9 is a greatly magnified, sectional view of the embodiment of FIG. 8, wherein the second continuous polymer layer, the porous polymer layer, and the first continuous polymer layer have been etched to form a trench.

FIG. 10 is a greatly magnified, sectional view of the embodiment of FIG. 9, wherein the etch stop layer has been etched to expose the electrically conductive layer.

FIG. 11 is a greatly magnified, sectional view of the embodiment of FIG. 10, wherein a continuous polymer overlayer has been deposited in the trench.

FIG. 12 is a greatly magnified, sectional view of the embodiment of FIG. 11, wherein portions of the continuous polymer overlayer have been etched away, leaving the continuous polymer overlayer over only the sides of the trench.

FIG. 13 is a schematic depiction of an embodiment of a deposition system suitable for forming a composite dielectric polymer film.

### DETAILED DESCRIPTION OF THE DEPICTED EMBODIMENTS

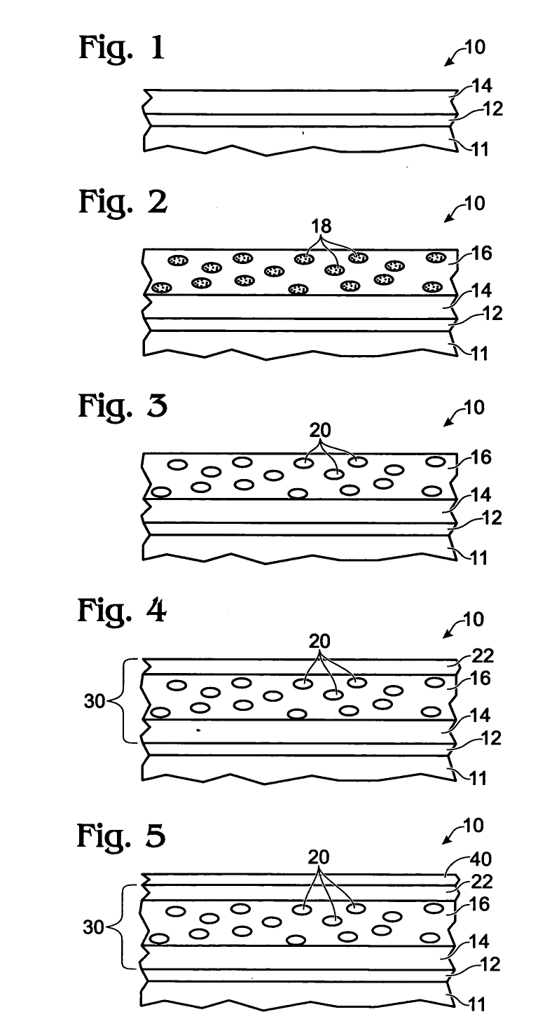

FIGS. 1-4 are sectional views of a substrate illustrating an embodiment of a method of fabricating a composite porous dielectric film including a porous polymer layer disposed between first and second continuous, or substantially non-porous, polymer layers. The use of the porous polymer layer helps to lower the overall dielectric constant of the film, while the first and second continuous polymer layers facilitate the deposition of other layers over the composite polymer dielectric film and the integration of the porous film into other fabrication processes. The term “substantially non-porous” or “non-porous” may be used herein to refer to an amount of porosity present in films deposited in the absence of a pore-forming component, but that may or may not have some small concentration of naturally-occurring pores.

The first and second continuous polymer layers may be formed from the same material (or a chemically similar material) as the porous polymer layer. This may allow the first and second continuous polymer layers to be formed via the same tool as the porous polymer layer. This may help to reduce the amount of time and cost required to form a composite porous dielectric film relative to the use of different tools for depositing the continuous layers and the porous layer.

FIG. 1 shows a substrate generally at 10, wherein the substrate includes an electrically conductive layer 11, an etch stop layer 12 formed on the electrically conductive layer 11, and a first continuous polymer dielectric layer 14 formed on the etch stop layer 12. The term “substrate” as used herein refers to the structure onto which any of the layers described herein are deposited. Therefore, once a layer is deposited, that layer becomes part of the “substrate” with reference to any later deposited films. Electrically conductive layer 11 may be formed from any suitable material. For example, where the depicted composite polymer dielectric film is to be used in a single damascene process (described in more detail below) or dual damascene process, electrically conductive layer 11 may be formed from a metallic material, including but not limited to copper or aluminum.

Likewise, etch stop layer 12 may also be formed from any suitable material. For example, where copper is utilized as electrically conductive material 11, suitable materials for etch stop layer 12 include, but are not limited to, SiC, SiCN, SiOCN, SiN and SiCOH. Etch stop layer 12 may help to slow down an etching process before the process reaches substrate 10, and also may help to prevent diffusion of copper from substrate 10 into first continuous polymer dielectric layer 14.

First continuous polymer dielectric layer 14 may be formed from any suitable polymer dielectric material. Examples include, but are not limited to, poly(paraxylylene) and fluorinated poly(paraxylylene) and derivates thereof, and other polyaromatics and fluorinated polyaromatics prepared from a precursor or precursors having the following general structure (I).
X′ₘ—Ar—(CZZ′Y)ₙ (I)
In this formula, X′ and Y are leaving groups that can be removed to form a free radical for each removed leaving group, Ar is an aromatic group or a fluorine-substituted aromatic group to which m X′ groups and n CZZ′Y groups are bonded, and Z and Z′ are H, F or C₆H₅₋ₓFₓ (x=0, or an integer between 1 and 5). For example, where m=0 and n=2, removal of the leaving group Y from each CZZ′Y functional group yields the diradical Ar(CZZ′*)₂. Compounds in which Z and Z′ are F may have suitably low dielectric constants and improved thermal stability compared to similar compounds in which Z and Z′ are species other than F. Examples of suitable leaving groups for X′ and Y include, but are not limited to, ketene and carboxyl groups, bromine, iodine, —NR₂, —N⁺R₃, —SR, —SO₂R, —OR, ═N⁺═N—R, —C(O)N₂, and —OCF—CF₃ (wherein R is an alkyl or aromatic group). The numbers m and n in formula (I) may independently be either zero or an integer, and (n+m) is equal to or greater than two, but no greater than the total number of sp² hybridized carbons in the aromatic group that are available for substitution.

Ar in formula (I) may be any suitable aromatic group. Examples of suitable aromatic groups for Ar include, but are not limited to, the phenyl moiety C₆H₄₋ₙFₙ (n=0 to 4); the naphthenyl moiety C₁₀H₆₋ₙFₓ (n=0 to 6); the di-phenyl moiety C₁₂H₈₋ₙFₙ (n=0 to 8); the anthracenyl moiety C₁₂H₈₋ₙFₙ (n=0 to 8); the phenanthrenyl moiety C₁₄H₈₋ₙFₙ (n=0 to 8); the pyrenyl moiety C₁₆H₈₋ₙFₙ (n=0 to 8); and more complex combinations of the above moieties such as C₁₆H₁₀₋ₙFₙ (n=0 to 10). Isomers of various fluorine substitutions on the aromatic moieties are also included. More typically, Ar is C₆F₄, C₁₀F₆, or C₆F₄—C₆F₄.

In particular, first continuous polymer layer 14 may be formed from a polymer of a general class of polymers called poly(paraxylylene)s (“PPX”). This class of polymers has repeat units of (—CZ¹Z²—Ar—CZ³Z⁴-), wherein Z¹, Z², Z³ and Z⁴ are similar or different, and each individually are H, F or an alkyl or aromatic group. In one specific embodiment, a fluoropoly(paraxylylene) known as “PPX—F” is used. This polymer has a repeat unit of (—CF₂—C₆H₄—CF₂—), and may be formed from various precursors, including but not limited to BrCF₂—C₆H₄—CF₂Br.

Poly(paraxylylenes) and other polymers formed from precursors of general formula (I) may be formed via transport polymerization. Transport polymerization involves the generation of a gas-phase reactive intermediate from a precursor molecule at a location remote from a substrate surface, and then the transport of the gas-phase reactive intermediate to the substrate surface for polymerization. In the specific example of PPX—F formed from the precursor BrCF₂—C₆H₄—CF₂Br, the precursor may be converted by the removal of the bromine atoms into the reactive intermediate *CF₂—C₆H₄—CF₂*, wherein * denotes a free radical. This reactive intermediate may then be condensed onto a substrate surface, where polymerization takes place. Careful control of deposition chamber pressure, reactive intermediate feed rate and substrate surface temperature can result in the formation of a PPX—F film having a high level of initial crystallinity. The film may then be annealed to recrystallize it in a more dimensionally and thermally stable phase, as described in more detail below.

After forming first continuous polymer layer 14, a porous polymer layer 16 is formed over first continuous polymer layer 14. Porous polymer layer 16 includes a plurality of pores, or void spaces, within the matrix of layer 16. The presence of these pores helps to lower the dielectric constant of porous polymer layer 16 relative to a continuous polymer layer of the same material and thickness.

The formation of porous polymer layer 16 is illustrated in FIGS. 2 and 3. First referring to FIG. 2, porous polymer layer 16 is first deposited as a non-porous film (or “pre-porous” film) with a quantity of a pore-forming component 18 incorporated within the film. Then, referring to FIG. 3, the pore-forming component 18 is removed from layer 16, thereby forming pores 20 within layer 16.

Porous polymer layer 16 may be made from any suitable polymer. For example, porous polymer layer 16 may be made from the same polymer as first continuous polymer layer 14. This may be advantageous, as it may help to ensure that the thermal expansion characteristics, rigidity, phase boundaries and other physical characteristics of the first continuous polymer layer 14 and porous polymer layer 16 are the same. Furthermore, unreacted free radicals at the upper surface of first continuous polymer layer 14 are able to react with free radicals at the lower surface of porous polymer layer 16, thereby chemically bonding the continuous polymer layer 14 to the porous polymer layer 16. However, it will be appreciated that the porous polymer layer 16 and first continuous polymer layer 14 also may be made of different materials where desired.

Any suitable material may be used as pore-forming component. Suitable materials include materials that do not react with the polymer materials of layer 16 and layer 14, and materials that are capable of easily being removed from layer 16. In one embodiment, pore-forming component 18 includes an unreacted quantity of the precursor from which the reactive intermediate is formed. For example, where the precursor BrCF₂—C₆H₄—CF₂Br is used to deposit a PPX—F film via the reactive intermediate *CF₂—C₆H₄—CF₂*, the pore-forming component may include unreacted BrCF₂—C₆H₄—CF₂Br (and, in some embodiments, some partially reacted BrCF₂—C₆H₄—CF₂*). In this specific example, the precursor has a higher boiling temperature than the reactive intermediate *CF₂—C₆H₄—CF₂*. Thus, the precursor will condense on any wafer cooled sufficiently to condense the reactive intermediate. Then, after the formation of layer 16, the temperature of the substrate may be raised sufficiently to vaporize the unreacted precursor, thereby boiling the pore-forming component out of layer 16 and creating pores 20 in layer 16. In the specific example of BrCF₂—C₆H₄—CF₂Br as a pore-forming component, the pore-forming component may be removed from layer 16 by heating layer 16 to a temperature of between approximately 120 and 150° C.

It will be appreciated that any suitable material other than the precursor used to form layer 16 may be used as a pore-forming component. For example, where layer 16 is a specific PPX film, such as PPX—F examples of other suitable pore-forming components include, but are not limited to, PPX precursors with different functional groups than those of the PPX film (including precursors in monomer and dimer form), such as PPX—N precursors.

Where unreacted precursor is used as the pore-forming component, the unreacted precursor may be added from any suitable source. For example, U.S. patent application Ser. No. 10/854,776 of Lee, which was filed on May 25 and is hereby incorporated by reference in its entirety, discloses a thermal reactor suitable for forming reactive intermediates from various precursors, including but not limited to precursors having a general formula of BrCX¹X²—C₆H₄₋ₓFₓ—CX³X⁴Br. This reactor is highly efficient at removing Br from precursor molecules to create reactive intermediates in high yield. However, variables such as the temperature of the reactor, the flow rate of precursor into the reactor, etc. may be altered (for example, the temperature of the reactor may be lowered, or the feed rate may be increased) to cause some precursor to leave the reactor in an unreacted (or partially reacted) state, thereby causing some unreacted (or partially reacted) precursor to be incorporated into a growing polymer film. When it is desired to deposit a continuous film, the reactor conditions may be re-adjusted to decrease the amount of unreacted precursor leaving the reactor.

Additionally, a cold trap may be positioned between the reactor and deposition chamber. Due to the higher molecular weight of the unreacted precursor relative to the reactive intermediate, the unreacted precursor may have a higher melting point than the reactive intermediate. Thus, a cold trap set to a temperature between the melting point of the reactive intermediate and the melting point of the precursor may trap unreacted precursor when it is desired not to deposit a continuous film. The cold trap may be bypassed when it is desired to leave the unreacted precursor in the flow of reactive intermediate to deposit a porous film, or the temperature of the cold trap may be periodically raised to release and/or pass through unreacted and partially reacted precursor.

Alternatively, in another embodiment, a second, separate precursor source may be used to supply unreacted precursor (or other pore-forming component) to a deposition chamber to form porous polymer layer 16. In this embodiment, a first precursor source (which may include a cold trap) may be used to provide precursor to a reactor for forming reactive intermediates, and an essentially pure stream of reactive intermediates may be introduced into a deposition chamber with this source. Therefore, the first precursor source is used during the formation of both porous and non-porous polymer films. The second precursor source may be configured to supply unreacted precursor to the deposition chamber as a pore-forming component. Therefore, the second precursor source generally would be used only during the deposition of porous films. A deposition system suitable for forming porous films via any of these methods is described in more detail below.

The pore-forming component may be added to the second film in any suitable quantity or concentration. For example, where the pore-forming component is unreacted precursor, it may be present in the reactive intermediate in a concentration of approximately 0.001 to approximately 25 molar percent. It will be appreciated that this range is merely exemplary, and that the pore-forming component also may have any suitable concentration outside of this range.

The pore-forming component may be removed from layer 16 to form the pores in any suitable manner. For example, depending upon the pore-forming component used, the pore-forming component may be removed by vaporizing the pore-forming component. The pore-forming component may be vaporized by increasing the temperature of layer 16, by reducing the pressure within the deposition chamber, or in any other suitable manner. In the specific example where the pore-forming component is unreacted precursor having a formula of BrCX¹X²—C₆H₄₋ₓFₓ—CX³X⁴Br, the pore-forming component may be removed by heating layer 16 to a temperature of between 120 and 150° C. under a suitable atmosphere. Suitable atmospheres include, but are not limited to, inert, reducing atmospheres and/or non-oxidative atmospheres, and may be at a reduced pressure (including, but not limited to, medium and high vacuum pressures) relative to atmospheric pressure.

Porous polymer layer 16 may have pores 20 of any suitable size. For example, pores 20 may have a diameter between approximately 30 and 100 Å, or alternatively may have a pore size outside of this range. Likewise, porous polymer layer 16 may have any suitable total porosity. Examples of suitable total porosity include, but are not limited to, total porosities less than approximately 50%, and also those less than about 30%.

Next referring to FIG. 4, after forming porous polymer layer 16, a second continuous polymer layer 22 is deposited over porous polymer layer 16 to form the composite polymer dielectric film, which is indicated by bracket 30. Second continuous polymer layer 22 may be formed from the same polymer material as layers 16 and 14, or may be formed from a different polymer material. Forming second continuous polymer layer 22 from the same polymer material as layers 14 and 16 may offer the advantage that each layer has the same coefficients of thermal expansion, phase transitions, etc., and thus may help to improve the physical strength of the overall structure. Furthermore, forming each of first and second continuous polymer layers 14, 22 and porous polymer layer 16 from the same polymer material may allow a single tool to be used to deposit all three layers, and thus may help to save time and expense in the film deposition process. Alternatively, second continuous polymer layer 22 may be made from a chemically similar, but not identical, polymer as porous polymer layer 16, or a chemically different but physically compatible polymer. For example, where porous polymer layer 16 is formed from PPX—F, second continuous polymer layer 22 may be formed from another polymer of the general PPX structure, including but not limited to PPX—N (with a repeat unit of —CH₂—C₆H₄—CH₂—).

Composite polymer dielectric film 30 may have any suitable thickness. The thickness of composite polymer dielectric film 30 may depend upon the scale of the integrated circuit in which it is used, and suitable thicknesses may include thicknesses in the range of approximately 1000-2000 Å. For example, in the specific case of 45 to 32 nm integrated circuits, the overall thickness of composite polymer dielectric film 30 may be on the order of approximately 1000 Å. Likewise, in the specific case of 65 nm integrated circuits, composite polymer dielectric film 30 may have a thickness, for example, on the order of 1500 Å.

First continuous polymer layer 14 and second continuous polymer layer 22 may have any suitable thicknesses relative to porous polymer layer 16. Because porous polymer layer 16 has a lower effective dielectric constant than continuous polymer layers 14 and 22, porous polymer layer 16 may be thicker than continuous polymer layers 14 and 22 to lower the overall dielectric constant of composite polymer dielectric film 30. In one embodiment, each continuous polymer layer 14, 22 has a thickness of 100-400 Å or less, and the porous polymer layer 16 has a thickness of greater than 800-1800 Å. It will be appreciated that continuous polymer layers 14, 22 and porous polymer layer 16 may also have thicknesses outside of these ranges.

After deposition of second continuous polymer layer 22, composite polymer dielectric film 30 may be annealed. Annealing composite polymer dielectric film 30 may help the film in several ways. For example, in the specific example of many poly(paraxylylene)-based polymers, including but not limited to PPX—F and PPX—N, a polymer may have several different solid phases that exist at different temperatures and/or pressures. For example, many poly(paraxylylene)-based polymers include at least an alpha-1 phase, a beta-1 phase and a beta-2 phase.

The alpha-1 phase is a solid phase that exists at lower temperatures. Because the synthesis of PPX-based films by transport polymerization is often performed at low temperatures, relatively large amounts of alpha-1 phase PPX-based materials may be initially formed by transport polymerization. Many PPX materials undergo an irreversible phase transition between the alpha-1 phase and beta-1 phase when heated to a sufficiently high temperature. In this case, an annealing step may be used to convert an as-deposited PPX film to a more dimensionally stable beta-1 phase. Furthermore, many PPX materials undergo a reversible beta-1 to beta-2 phase transition at a higher temperature. It has been found that many PPX-based polymers can be trapped in the beta-2 phase by first heating to a temperature above the beta-1 to beta-2 phase transition temperature, holding the PPX-based film at an elevated temperature for a duration of, for example, 1-120 minutes, and then cooling the film at a fairly rapid rate, for example, between 30 and 50° C./sec, to a temperature below the beta-1 to beta-2 phase transition temperature. In this case, an annealing step followed by a rapid cooling step may be used to trap a film in a beta-2 phase so that, in the event that the film will have to undergo further processing steps at temperatures higher than the beta-1 to beta-2 phase transition temperature, no dimension-changing beta-1 to beta-2 phase transition will occur.

Any suitable annealing process may be used to anneal composite polymer dielectric film 30. For example, polymer dielectric film 30 may be annealed under any suitable pressure, and under any suitable atmospheric composition. In one embodiment, polymer dielectric film 30 is annealed under a reducing atmosphere. The use of a reducing atmosphere may help to cap any unreacted free radicals with a species such as hydrogen or fluorine. Examples of suitable reducing atmospheres include, but are not limited to, fluorine, hydrogen, fluorine or hydrogen mixed with argon, and fluorine or hydrogen mixed with nitrogen. Where hydrogen is mixed with a diluent gas, suitable concentrations of hydrogen gas include, but are not limited to, concentrations greater than 0.1% by volume. Furthermore, a silane compound may be included in the reductive atmosphere as an adhesion-promoting compound to improve adhesion at organic-inorganic interfaces. Examples of suitable silane compounds include, but are not limited to, those silane compounds listed in U.S. patent application Ser. No. 10/816,205 of Lee, filed on Mar. 31, 2004, the disclosure of which is hereby incorporated by reference.

To avoid free radical scavengers such as oxygen from contaminating the film by reacting with unreacted free radicals, the anneal may be performed in a system having a low leakage rate. Suitable leakage rates include, but are not limited to, leakage rates below 0.5 mT/min, but this quantity is chamber volume dependent.

The annealing process may be performed at any suitable pressure. Suitable pressures include, but are not limited to, pressures between approximately 2 and 10 Torr. Likewise, any suitable heat source may be used for the annealing process. Suitable heat sources include, but are not limited to, hot plates, radiant heat sources, etc.

Composite polymer dielectric film 30 may be annealed at any suitable temperature. In the specific example of PPX—F, composite polymer dielectric film may be annealed at a temperature, for example, between 50° to 90° C. below a melting temperature of the film. The film is then maintained at isothermal temperature for a period of time, including but not limited to periods of time between about 1 and 120 minutes. The film is then cooled to give the final composite polymer dielectric film 30. In the specific example of PPX—F, the cooling rate is between about 30° C. and about 100° C./min, and film 30 is cooled at this rate to a temperature that is about 20° to about 50° C. below the beta-1 to beta-2 phase transition temperature.

Composite polymer dielectric film 30 may be used in many common integrated circuit structures and processes. For example, composite polymer dielectric film 30 may be used in single damascene and dual damascene methods of forming conductive interconnects. Briefly, these techniques involve forming a trench or via in a dielectric layer, depositing a barrier layer (typically of tantalum) within the trench, depositing a seed layer of copper over the tantalum, filling the rest of the trench with copper via electroplating, and then removing excess copper from around the trench via a polishing process.

FIGS. 5-11 illustrate one embodiment of a method of preparing a trench in composite polymer dielectric film 30 for the later formation of a conductive line via a damascene process (not shown). First referring to FIG. 5, a hard mask layer 40 is deposited over second continuous polymer layer 22. Hard mask layer 40 is typically used to protect second continuous polymer layer 22 from damage caused by the polishing step in a damascene process. Hard mask layer 40 may be formed from any suitable material. Examples of suitable materials include, but are not limited to, SiC, SiCN, SiOCN, SiN and SiCOH.

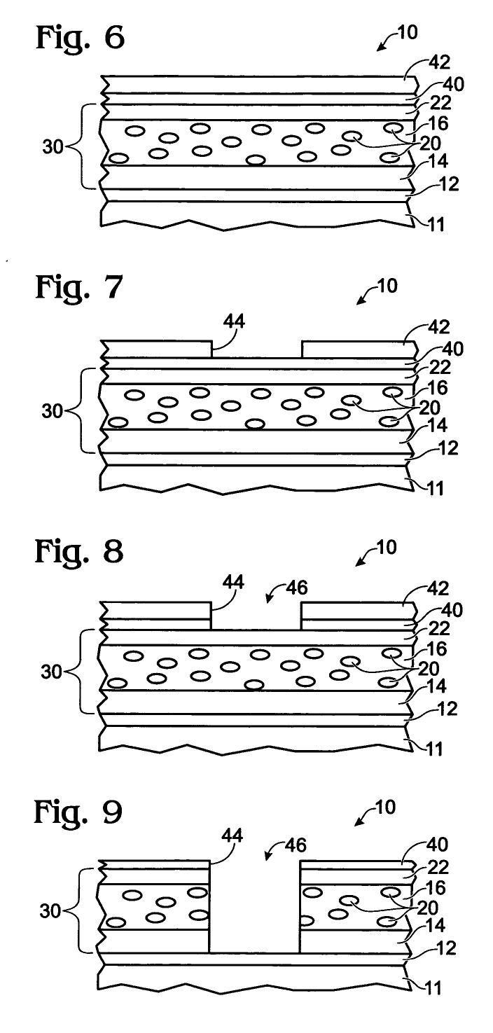

Next referring to FIG. 6, a layer of a patternable resist material 42 is deposited over hard mask layer 40. Layer of resist material 42 is next exposed to a pattern and developed, which removes selected portions of resist layer 42, as illustrated in FIG. 7. Next, as shown in FIG. 8, an etching process is used to etch away those portions of hard mask layer 40 that were exposed by the resist development step.

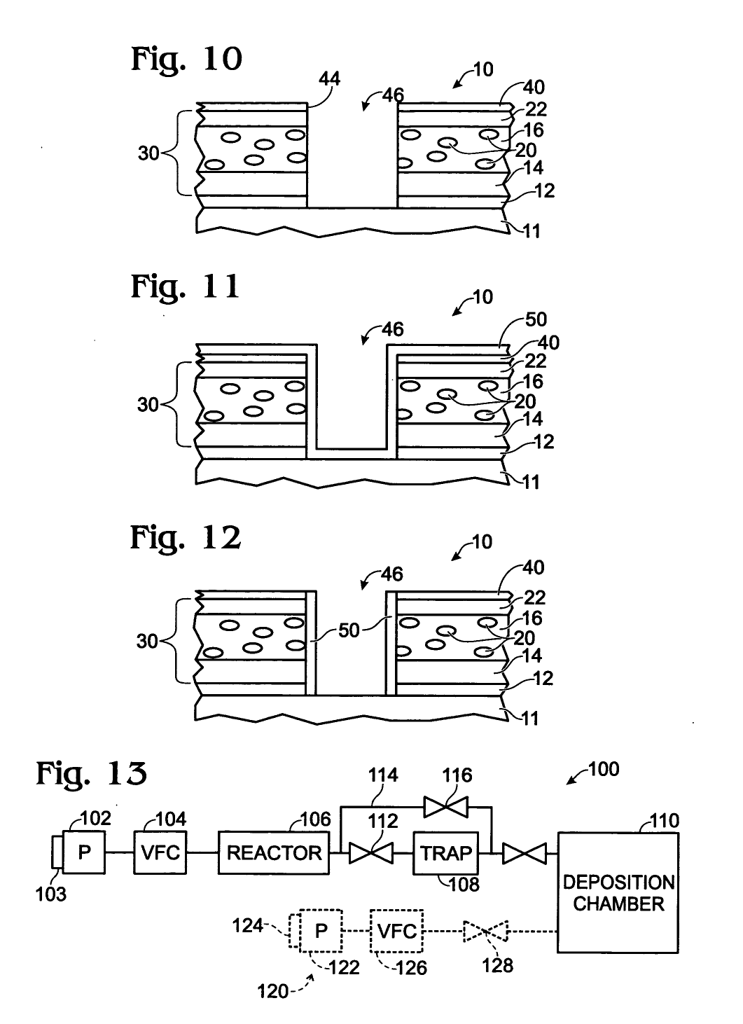

The etching of hard mask layer 40 exposes the top surface of composite polymer dielectric film 30. Next, as shown in FIG. 9, a trench 46 is etched in composite polymer dielectric film 30, exposing etch stop layer 12. The etching of film 30 also typically etches away remaining portions of resist layer 42. If the etching of composite polymer dielectric film 30 does not completely remove resist layer 42, any remaining portions of resist layer 42 may be removed in a separate step (not shown).

Etch stop layer 12 is next etched away, as shown in FIG. 10, exposing electrically conductive layer 10. After etching the etch stop layer 12, the structure may be annealed under a reducing environment as described above to repair any damage to composite polymer layer 30 caused by the etching processes. The etching processes for the above-described etching steps are well known in the semiconductor processing arts, and therefore are not described in further detail herein.

Etching trench 46 through composite polymer dielectric film 30 exposes a portion of porous polymer layer 16 within trench 46. As described above, it may be difficult under some circumstances to deposit materials over the exposed portion of porous layer 16. Therefore, in these circumstances, an additional layer of polymer material 50 may be deposited on the sides of trench 46 to cover the exposed portions of porous polymer layer 16.

FIGS. 11 and 12 show one suitable method of covering the exposed portions of porous polymer layer 16. First, as shown in FIG. 11, a continuous layer of a low dielectric constant polymer material 50 may be deposited over the sides and bottom of trench 46, as well as areas of hard mask layer 40 adjacent to trench 46. Layer 50 may be referred to herein as a “polymer overlayer.” Next, an anisotropic etching step may be used to remove those portions of polymer overlayer 50 that are located at the bottom of trench 46 and on surfaces adjacent to trench 46. As shown in FIG. 12, this leaves polymer overlayer 50 covering only the sides of trench 46, thereby covering any exposed portions of porous polymer layer 16 with polymer overlayer 50. If desired, polymer overlayer 50 may be annealed as described above in the context of composite film 30 before performing additional steps in a damascene process.

While the embodiment shown in FIGS. 5-12 depicts a method of forming a trench suitable for use in a single damascene process, it will be appreciated that the methods described herein may be easily adapted to dual damascene methods.

A composite dielectric polymer film as disclosed herein may be formed via any suitable deposition system. For example, in the specific case of PPX—F, the composite polymer dielectric film may be formed via a transport polymerization deposition system capable of growing highly crystalline PPX—F via transport polymerization of a reactive intermediate. Furthermore, such a deposition system also would include a source of a pore-forming component configured to provide a quantity of gas-phase pore-forming component to the deposition chamber simultaneously with the reactive intermediate for the transport polymerization reaction.

FIG. 13 shows, generally at 100, a simple schematic diagram of a system suitable for forming composite dielectric film 30. The system includes a precursor source 102, and a heater 103 for heating the precursor source. Flow of precursor vapor out of precursor source 102 may be controlled by a vapor flow controller 104 or other suitable device. A reactor 106 for converting the precursor into reactive intermediates is positioned downstream of vapor flow controller 104. Where the reactive intermediate has the general formula of Ar(CZ′Z″*)ₙ or, more generally, *CZ¹Z²ArCZ³Z⁴* (for example, *CF₂C₆H₅CF₂*), reactor 106 may be configured to remove a leaving group Y from a precursor of the general formula of (YCZ¹Z²ArCZ³Z⁴Y)₂ to form the reactive intermediate, or may be configured to crack a dimer of the general formula (Ar(CZ′Z″Y)₂)₂ to form the reactive intermediate. Removal of a leaving group may be more commonly used for PPX—F, while cracking of a dimer (the “Gorham method”) may be more commonly used for PPX—N.

Downstream of the reactor 106 is a cold trap 108 configured to be held at a temperature between the melting point of the precursor (or the melting point of partially reacted precursor) and the melting point of the reactive intermediate to remove unreacted (i.e. no leaving groups removed) or partially reacted (i.e. one or more, but not all, leaving groups removed) precursor from the outflow of reactor 106 before the outflow enters a deposition chamber 110. Removing unreacted and partially reacted precursor during the growth of continuous films may help to grow continuous films with better physical characteristics, as partially reacted precursor may terminate growing polymer chains in composite polymer dielectric film 30, and unreacted precursor may cause the formation of unwanted pores in a continuous film.

System 100 also includes a valve 112 positioned upstream of cold trap 108, and a bypass line 114 (also with a valve 116) directed around cold trap 108. When it is desired to deposit a continuous film, valve 112 may be opened and valve 116 may be closed, directing the outflow from reactor 106 through cold trap 108. On the other hand, when it is desired to deposit a porous film, valve 112 may be closed and valve 116 may be opened, directing the outflow from reactor 106 directly into deposition chamber 110. In this manner, unreacted and partially reacted precursor molecules may be incorporated in the growing polymer film, and then later removed from the film to create pores in the film.

Alternatively, instead of using bypass line 114 to admit unreacted and partially reacted precursor molecules into deposition chamber 110, the temperature of cold trap 108 may be periodically raised to release trapped unreacted and partially reacted precursor molecules into deposition chamber 110, and to allow these species to flow through to the deposition chamber 110.

Also, instead of using bypass line 114, system 100 may include a separate supply of pore-forming component. An exemplary pore-forming component supply is shown generally at 120 in FIG. 13. Pore-forming component supply 120 includes a pore-forming component source 122, and may include a heater 124 or other energy source for vaporizing the pore-forming component in the source (depending upon the vaporization temperature of the pore-forming component). Pore-forming component supply 120 also may include a vapor flow controller 126 for controlling the quantity of pore-forming component that flows out of source 122, and may include a valve 128 to allow a flow of the pore-forming component into deposition chamber 110 to be turned on or off. In this embodiment, cold trap bypass line 114 may be omitted, and the temperature of the cold trap may be maintained at a low-enough temperature to trap unreacted and partially reacted precursor molecules.

When it is desired to deposit a continuous layer, valve 128 and/or vapor flow controller 126 may be closed to prevent the flow of the pore-forming component into deposition chamber 110. When it is desired to deposit a porous layer, valve 128 and/or vapor flow controller 126 may be opened to allow the pore-forming component to flow into deposition chamber 110 to thereby be incorporated into the growing polymer film. Furthermore, deposition chamber 110 may be equipped with an energy source (not shown), such as a temperature-controlled chuck, a heater or other energy source to provide energy to vaporize the pore-forming component within the polymer film and form pores in the film. Alternatively, the pore-forming component may be removed from the film via any other suitable means.

Although the present disclosure includes specific embodiments of various composite porous dielectric films, methods of forming the films, and systems for forming the films, specific embodiments are not to be considered in a limiting sense, because numerous variations are possible. The subject matter of the present disclosure includes all novel and nonobvious combinations and subcombinations of the various films, processing systems, processing methods and other elements, features, functions, and/or properties disclosed herein. The description and examples contained herein are not intended to limit the scope of the invention, but are included for illustration purposes only. It is to be understood that other embodiments of the invention can be developed and fall within the spirit and scope of the invention and claims.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A method of forming a composite dielectric polymer thin film on a substrate, the method comprising:
forming a first substantially continuous layer of a dielectric polymer material on the substrate;
forming a porous layer of the dielectric polymer material on the first, substantially continuous layer; and
forming a second substantially continuous layer of the dielectric polymer material on the porous layer.

2. The method of claim 1, wherein the layers are each formed from a precursor having a general formula of Xₐ—Ar—(CZZ′Y_{b}), wherein X and Y are leaving groups, Z and Z′ are each selected from the group consisting of H, F, alkyl groups and aromatic groups, Ar is an aromatic moiety, a and b are each zero or an integer, and a+b is equal to or less than a total number of sp² hybridized carbons in Ar available for substitution.

3. The method of claim 2, wherein the layers are each formed from a polymer having a repeat unit of (—CF₂C₆H₄CF₂—).

4. The method of claim 1, wherein forming each of the layers includes depositing each of the layers by transport polymerization.

5. The method of claim 4, wherein depositing the porous layer by transport polymerization includes depositing a pre-porous layer by transport polymerization of a reactive intermediate having a general formula of Ar—(CZZ′*₂) in a presence of a pore-forming compound having a general formula of Ar—(CZZ′Y₂), and then heating the pre-porous layer to remove the pore-forming compound, thereby forming the porous layer.

6. The method of claim 5, wherein Y is selected from the group consisting of NR₂, —N⁺R₃, —SR, —SO₂R, —OR, ═N⁺═N—R, —C(O)N₂, and —OCF—CF₃, wherein R is an alkyl or aromatic group.

7. The method of claim 5, wherein the porous film is formed by including between approximately 0.001 and 25 molar percent of the pore-forming compound in the reactive intermediate.

8. The method of claim 1, wherein forming the porous layer includes incorporating a pore-forming material in a pre-porous layer, and then heating the pre-porous layer to remove the pore-forming material, thereby forming the porous layer.

9. The method of claim 8, wherein heating the pre-porous layer includes heating the pre-porous layer under at least one of an inert, reductive and non-oxidative atmosphere.

10. The method of claim 9, wherein heating the pre-porous layer includes heating the pre-porous layer under a reduced pressure relative to atmospheric pressure.

11. The method of claim 9, wherein heating the pre-porous layer under a reductive atmosphere includes heating the pre-porous layer in a presence of hydrogen.

12. The method of claim 8, wherein heating the pre-porous layer under a reductive atmosphere includes heating the pre-porous layer in a presence of fluorine.

13. The method of claim 8, wherein heating the pre-porous layer under a reductive atmosphere includes heating the pre-porous layer in a presence of a silane compound.

14. The method of claim 8, wherein heating the pre-porous layer includes heating the pre-porous layer to a temperature of between 50 and 90 degrees Celsius below a melting temperature of the dielectric polymer material.

15. The method of claim 1, wherein forming a porous layer of the dielectric polymer material includes forming a porous layer having 50% or less porous space by total layer volume.

16. The method of claim 1, wherein forming a porous layer of the dielectric polymer material includes forming a porous layer having pores with an average diameter of 100 Å or less.

17. The method of claim 1, further comprising etching through the composite polymer dielectric film after forming the composite polymer dielectric thin film, and then depositing a third substantially continuous layer of the dielectric polymer material over at least portions of the porous layer that are exposed.

18. The method of claim 17, further comprising annealing the composite polymer dielectric film under a reducing atmosphere after etching and before depositing the third substantially continuous layer of the dielectric polymer material.

19. A method of fabricating a dielectric polymer thin film on a substrate, the method comprising:
forming a first continuous layer of a dielectric polymer material on the substrate;
forming a pre-porous layer of the dielectric polymer material on the first continuous layer, wherein a pore-creating component is incorporated in the pre-porous layer;
heating the pre-porous layer of the dielectric polymer material to remove the pore-forming component from the pre-porous layer, thereby creating a porous layer; and
forming a second continuous layer of the dielectric polymer material on the porous layer.

20. The method of claim 19, wherein the layers are each formed from a precursor having a general formula of Xₐ—Ar—(CZZ′Y_{b}), wherein X and Y are leaving groups, Z and Z′ are each selected from the group consisting of H, F, alkyl groups and aromatic groups, Ar is an aromatic moiety, a and b are each zero or an integer, and a sum of a and b is equal to or less than a total number of sp² hybridized carbons in Ar available for substitution.

21. The method of claim 19, wherein the first and second continuous layers are formed via the transport polymerization of a free radical species, and wherein the pre-porous layer is formed via the transport polymerization of the free radical species in the presence of the pore-forming compound.

22. The method of claim 21, wherein the free radical species has a general formula of C₆H₄(CF₂*)₂, wherein * denotes an unpaired electron, and wherein the pore-forming component has a general formula of C₆H₄(CF₂Y)₂, (wherein Y is a leaving group).

23. The method of claim 22, wherein the free radical species and the pore-forming compound are supplied from different sources.

24. The method of claim 19, wherein heating the pre-porous layer includes heating the pre-porous layer to a temperature of between 50 and 90 degrees Celsius below a melting point of the dielectric polymer material.

25. The method of claim 19, wherein heating the pre-porous layer includes heating the pre-porous layer under at least one of an inert, reductive and non-oxidative atmosphere.

26. The method of claim 25, wherein heating the pre-porous layer includes heating the pre-porous layer under a reduced pressure relative to atmospheric pressure.

27. The method of claim 19, further comprising etching through the composite polymer dielectric thin film to expose an underlying electrically conductive layer, and then depositing a third continuous layer of the dielectric polymer material over at least portions of the second layer that are exposed by the etching.

28. The method of claim 27, further comprising annealing the composite polymer dielectric film under a reducing atmosphere after etching and before depositing the third continuous layer.

29. In an integrated circuit, a composite polymer dielectric film, comprising:
a first substantially non-porous polymer layer;
a porous polymer layer in contact with the first substantially non-porous polymer layer; and
a second substantially non-porous polymer layer in contact with the porous polymer layer.

30. The integrated circuit of claim 29, wherein the layers are each made of a polymer formed from a precursor having a general formula of Xₐ—Ar—(CZZ′Y_{b}), wherein X and Y are leaving groups, Z and Z′ are each selected from the group consisting of H, F, alkyl moieties and aromatic moieties, Ar is an aromatic moiety, a and b are each zero or an integer, and a sum of a and b is equal to or less than a total number of sp² hybridized carbons in Ar available for substitution.

31. The integrated circuit of claim 30, wherein the layers are each made of a polymer having a repeat unit of (—CF₂C₆H₄CF₂—)ₓ.

32. The integrated circuit of claim 31, wherein the polymer having a repeat unit of (—CF₂C₆H₄CF₂—)ₓ includes chain ends capped by at least one of hydrogen and fluorine.

33. The integrated circuit of claim 29, wherein the porous polymer layer includes pores having an average diameter of 100 Å or less.

34. The integrated circuit of claim 29, wherein the first substantially non-porous layer has a thickness of approximately 100-400 Å.

35. The integrated circuit of claim 29, wherein the porous layer has a thickness of approximately 800-1800 Å.

36. The integrated circuit of claim 29, wherein the composite dielectric film has an overall thickness of approximately 1000-2000 Å.

37. The integrated circuit of claim 29, further comprising a trench etched at least partially through the composite dielectric film, and further comprising a third substantially non-porous polymer layer lining the trench.

38. The integrated circuit of claim 29, wherein the composite polymer dielectric film has a dielectric constant of approximately 2 or less.

39. In an integrated circuit, a poly(paraxylylene)-based composite low dielectric constant polymer film, comprising a porous poly(paraxylylene)-based polymer layer disposed between and in contact with a pair of substantially non-porous poly(paraxylylene)-based polymer layers.

40. The integrated circuit of claim 39, wherein the porous poly(paraxylylene)-based polymer layer includes pores having an average diameter of 100 Å or less.

41. The integrated circuit of claim 39, wherein the porous poly(paraxylylene)-based polymer layer has 50% or less porous space by total layer volume.

42. The integrated circuit of claim 39, wherein the poly(paraxylylene)-based composite low dielectric constant polymer film has a dielectric constant of approximately 2 or less.
